(19) United States
(12) Patent Application Publication
(10) Pub. No.: US 2010/0030703 A1
(43) Pub. Date: Feb. 4, 2010

(54) SYSTEM AND METHOD FOR MANAGING CROSS-BORDER FINANCING

(76) Inventors: Chi Hsiu Hsin, Franklin Square, NY (US); Chai Im, Hartsdale, NY (US)

Correspondence Address: FULBRIGHT & JAWORSKI, LLP, 666 FIFTH AVE, NEW YORK, NY, 10103-3198, US

(21) Appl. No.: 12/576,686

(22) Filed: Oct. 9, 2009

Related U.S. Application Data
(63) Continuation-in-part of application No. 11/387,543, filed on Mar. 22, 2006.

(51) Int. Cl. G06Q 40/00; G06F 17/30

(52) U.S. Cl. 705/36 R; 707/104.1

(57) ABSTRACT

A system and method for managing cross-border financing based on an investing entity's investment in a domestic company holding interests in a plurality of foreign companies. The domestic company gives the investing entity the right or warrant to invest, acquire, control or manage one or more foreign companies. The investing entity can directly invest in a foreign company by investing in a domestic company.

### RELATED APPLICATION

The present application is a continuation-in-part of application Ser. No. 11/387,543, filed Mar. 22, 2006, which is incorporated herein in its entirety.

### FIELD OF THE INVENTION

The claimed invention relates to a system and method for managing cross-border financing, particularly, a cross-border financing that enables an investing entity (an investor or a company) to safely and efficiently invest in a foreign company in a foreign jurisdiction by investing in a domestic company.

### BACKGROUND OF INVENTION

International transactions, e.g., mergers, acquisitions, etc., are on the rise all over the world. Companies can grow only so much organically, so they seek to invest or acquire another company to sustain their growth. Big multi-national companies generally have vast resources to undertake foreign acquisitions to establish a presence in such foreign markets or to tap into their lower cost structure. For example, many software or computer service companies have established a presence in India or acquired Indian software companies to lower their cost structure to be competitive in the global market place. Also, American and European car companies have invested in or acquired Asian car companies to acquire their ability to make small affordable cars.

Such foreign acquisitions or investments are also desirable for smaller or mid-size companies, but they are cost prohibitive under the current international financing and investment structure. Their cost structures are also under tremendous competitive pressure from foreign competitions, particularly from underdeveloped countries. However, the high cost and high risk involved in foreign acquisitions and investments prohibits such small and mid-size companies from pursuing such international transactions. The company must find a suitable foreign target company, conduct due diligence on that foreign target company and deal with host of issues, such as regulations and rules involving transfer of foreign currency, investing in foreign companies, etc.

Therefore, it is desirable to have an international financing and investment structure that enables any investor and company to efficiently participate in a foreign acquisition and investment.

### SUMMARY OF THE INVENTION

The claimed invention provides a financing and investment structure that facilitates international investment and acquisition that overcomes the cost prohibitive problem associated with currently available investment structure.

In accordance with an embodiment of the claimed invention, the financing and investment structure, as aforesaid, comprises a financing instrument in foreign currency based on investment in a private or publicly traded domestic company (“domestic company”) holding interests in a plurality of private and/or public foreign companies, including state owned enterprises, to enable an investing entity to invest in at least one of the foreign companies.

In accordance with an embodiment of the claimed invention, the method of investing in a public or private foreign company, comprising the steps of investing, selecting and arranging financing. An investing entity invests in a private or publicly traded domestic company (“domestic company”) holding interests in a plurality of public and/or private foreign companies, including state owned enterprises (“foreign companies”). The domestic company essentially gives the investing entity the right or warrant to invest, acquire, control or manage one or more foreign companies. The investing entity based on its investment in the domestic company selects at least one foreign company from the plurality of foreign companies. The domestic company arranges direct or indirect financing in a jurisdiction of the selected foreign company, thereby enabling the investing entity to invest in the selected foreign company. Preferably, the financing amount is equal to or less than the investing entity's investment in the domestic company. In accordance with an aspect of the claimed invention, the financing is in a currency of the foreign company.

In accordance with an embodiment of the claimed invention, a computer based system for managing an investment in a foreign company comprising an investment module, a foreign company module, a financing module and a database. The investment module processes investment by an investing entity in a domestic company holding interests in a plurality of foreign companies. A list of foreign companies that a particular domestic company holds interest in is stored in the database. The foreign company module enables the investing entity to select at least one foreign company from the plurality of public and/or private foreign companies, including state owned enterprises. Preferably, the foreign company module provides description of each foreign company, including management, business and/or financial information, stored in the database. The financing module transmits financing information available in a jurisdiction of the selected foreign company to enable the investing entity to directly invest in the selected foreign company by simply investing in the domestic company.

In accordance with an exemplary embodiment of the claimed invention, a computer based method for managing cross-border financing and an investment over a communications network comprises the step of accessing a processor based server over the communications network by an investing entity using an associated computer to obtain cross-border financing to directly invest in a foreign company. The processor based server manages investment in a plurality of domestic and foreign companies. Each domestic company operating in one jurisdiction holds interests in a plurality of foreign companies operating in another jurisdiction. Each foreign company on the list meeting one or more predetermined financial criteria established by each domestic company. The computer associated with the investing entity receives a list of the plurality of domestic companies stored in a database from the processor based server over the communications network. The investing entity uses the associated computer to transmit its selection of a domestic company, an investment amount and the investment information to the processor based server over the communications network. A list of foreign companies stored in the database is received by the computer associated with the investing entity from the processor based server over the communications network after the processor based server processes and validates the investment amount and said investment information received from the investing entity. The selected domestic company holds an interest in each foreign company on the list of foreign companies. The investing entity transmits its selection of a foreign company from the list of foreign companies to the processor based server using the associated computer over the communications network. The computer associated with the investing entity receives financial information of the selected foreign company stored in the database and the cross-border financing information from the processor based server to directly invest in the selected foreign company in the foreign jurisdiction by investing in the selected domestic company by the investing entity.

In accordance with an exemplary embodiment of the claimed invention, a computer readable medium comprises computer executable code for managing cross-border financing and an investment over a communications network. The computer executable code comprises instructions for accessing the processor based server by a computer associated with an investing entity to obtain cross-border financing to directly invest in a foreign company. The processor based server manages investment in a plurality of domestic and foreign companies. Each domestic company operating in one jurisdiction holds interests in a plurality of foreign companies operating in another jurisdiction. Each foreign company on the list meeting one or more predetermined financial criteria established by each domestic company. The computer associated with the investing entity receives a list of the plurality of domestic companies stored in a database from the processor based server over the communications network. The investing entity uses the associated computer to transmit its selection of a domestic company, an investment amount and the investment information to the processor based server over the communications network. A list of foreign companies stored in the database is received by the computer associated with the investing entity from the processor based server over the communications network after the processor based server processes and validates the investment amount and said investment information received from the investing entity. The selected domestic company holds an interest in each foreign company on the list of foreign companies. The investing entity transmits its selection of a foreign company from the list of foreign companies to the processor based server using the associated computer over the communications network. The computer associated with the investing entity receives financial information of the selected foreign company stored in the database and the cross-border financing information from the processor based server to directly invest in the selected foreign company in the foreign jurisdiction by investing in the selected domestic company by the investing entity.

In accordance with an exemplary embodiment of the claimed invention, the investment amount and the investment information provided by the investing entity must satisfy a predetermined criteria established by the selected domestic company to obtain cross-border financing.

In accordance with an exemplary embodiment of the claimed invention, the computer associated with the investing entity receives information about each of the plurality of foreign companies from the processor based server over the communications network.

In accordance with an exemplary embodiment of the claimed invention, the financing amount (which can be in the currency of the selected foreign company or the) is less than or equal to the amount of the investing entity's investment in the domestic company.

Various other objects, advantages and features of the claimed invention will become readily apparent from the ensuing detailed description, and the novel features will be particularly pointed out in the appended claims.

### BRIEF DESCRIPTION OF THE DRAWINGS

These and other advantages of the claimed invention will be described in detail with reference to the following drawings in which like reference numbers refer to like elements:

FIG. 1 is a schematic diagram of a cross-border investment involving various parties in accordance with an exemplary embodiment of the claimed invention;

FIG. 2 is a flow chart describing the process of investing in a foreign company in accordance with an exemplary embodiment of the claimed invention; and

FIG. 3 is a schematic diagram of a system for managing cross-border financing in accordance with an exemplary embodiment of the claimed invention.

### DETAILED DESCRIPTION OF THE EMBODIMENTS

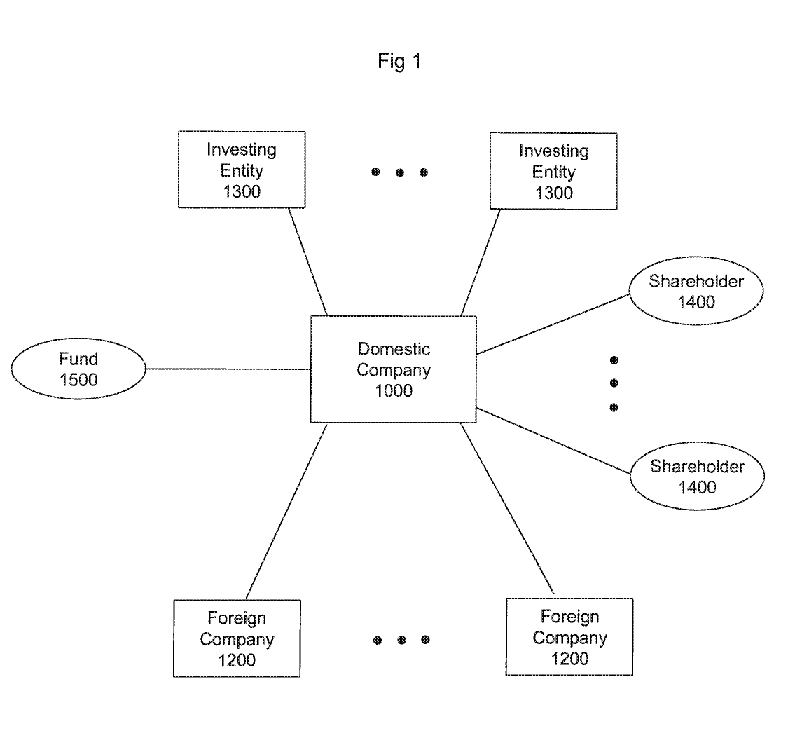

Turning now to FIG. 1, in accordance with an embodiment of the claimed invention, there is illustrated a cross-border investment involving various parties, which comprises a private or publicly traded company 1000 (referred to herein as the “domestic company”) that owns or has rights to a portfolio of private and/or public companies 1200, including state owned enterprises, in another country (referred to herein as the “foreign companies”). The investor or a company 1300 (collectively referred to herein as the “investing entity”) invests in the domestic company 1000 to invest, acquire or manage one or more of the domestic company's portfolio of foreign companies 1200.

In accordance with an exemplary embodiment, the domestic company 1000 owns or has rights to a portfolio of public and/or private Chinese textile companies 1200. Alternatively, the domestic company 1000 may own or have rights to a portfolio of companies 1200 spanning many industries, e.g., textile, financial, insurance, hotel, etc. Much of the investment related work, such as identifying appropriate textile companies, legal and financial due diligence, agreements, etc., can be performed by the domestic company 1000 and/or its agents. The investing entity 1300 desirous of investing US $1 million in a Chinese textile company 1200 can now simply invest the $1 million in the domestic company 1000. For such investment in the domestic company 1000, the investing entity 1300 obtains a right or warrant to acquire, invest or manage one or more Chinese textile company 1200 in the domestic company's portfolio of Chinese textile companies 1200.

The Chinese textile companies 1200 benefits because they have access to foreign capital and is now part of a company in the developed capital market, e.g., a publicly listed US or European company. This provides added prestige and leverage to the Chinese textile companies in their home market because they have access to US or European capital and an opportunity to be affiliated with a US or European company.

In accordance with an embodiment of the claimed invention, the domestic company 1000 or its foreign agent (e.g., an affiliated or unrelated Chinese entity in this particular example) can provide or arrange credit facility, e.g., bank loan, to the investing entity 1300. Since the investing 1300 entity typically has no presence in foreign jurisdiction (i.e. China), they will have great difficulties in receiving capital from Chinese banks and financial institutions 3100. The domestic company 1000 and/or its foreign agent can arrange credit facility on behalf of the investing entity 1300. Preferably, the amount of the credit facility in the foreign country (i.e., China in this example) is limited to the amount equal to the investing entity's investment in the domestic company 1000. That is, the investing entity's investment in the domestic company 1000 can serve as collateral for this loan. The investing entity 1300 can then use this credit facility to invest, acquire, control or manage one or more of the Chinese textile companies 1200 from the domestic company 1000. This advantageously provides the investing entity 1300 with quick access to foreign capital by leveraging the domestic company's and/or its agent's financial and banking relationships in that foreign jurisdiction. Additionally, this advantageously enables the investing entity 1300 to quickly expand into foreign markets without building its own infrastructure in that foreign market.

In accordance with an embodiment of the claimed invention, a system 3000 is provided for managing the international financing and investment structure as described herein. The investment entity 1300 invests an investment amount in a domestic company 1000 of the claimed invention and is granted a right or warrant to invest, acquire, control or manage one or more foreign companies 1200 owned, controlled or managed by the domestic company 1000. That is, the investing entity 1300 selects one or more foreign companies 1200 owned or controlled by the domestic company 1000. The domestic company 1000 can own or control companies 1200 in only one foreign jurisdiction or multiple foreign jurisdictions. Also, the domestic company 1000 can own or control companies in one industry or multiple industries. The system 3000 initiates a process for opening credit facility on behalf of the investing entity 1300 in a jurisdiction of the foreign company 1200 selected by the investing entity 1300. The investing entity 1300 invests in the selected company using the fund available from the credit facility in the selected country. Preferably, the available fund is in the amount equal to or less than the amount of the investing entity's investment in the domestic company 1000. Alternatively, the investing entity 1300 can use the fund to acquire a controlling stake to manage the selected company or own the selected company in its entirety (this may depend on foreign ownership rules and regulations in the selected company).

In accordance with an embodiment of the claimed invention, the financing and investment structure of the claimed invention can be setup so various investing entities 1300 can invest in one type of industry in one country, in multiple industries in one country, one type of industry in multiple countries (e.g., a particular region or all over the world) or multiple industries in multiple countries. That is, the financing and investment structure can be setup so that investing entities 1300 in can invest in Indian outsourcing companies, Chinese textile companies, Chinese funeral homes, Asian hotels, European hotels, East European steel mills, cellular phone services in Asia, global pharmaceutical companies, etc.

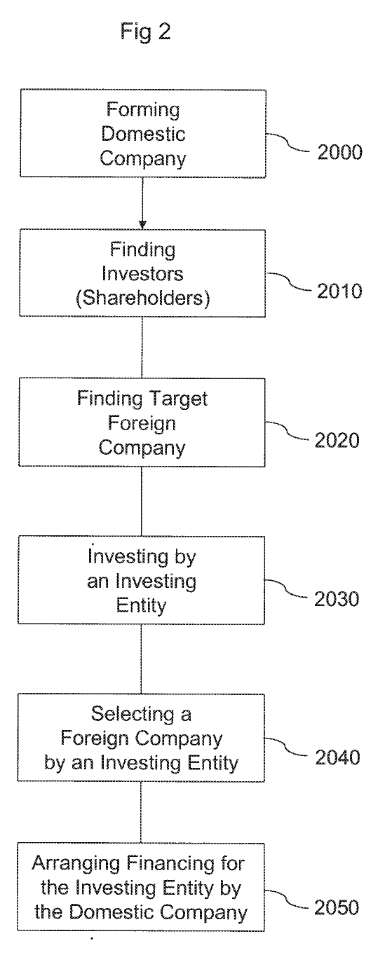

In accordance with an embodiment of the claimed invention, a method of investing in a foreign company is now described in conjunction with FIG. 2. A domestic company is formed or established in step 2000. In accordance with an aspect of the claimed invention, the domestic company 1000 is a publicly listed US company formed via any known methods complying with appropriate rules and regulations, e.g., a special purpose acquisition company (“SPAC”) or a blank check company, reverse-merger, reverse triangular merger and the like. A blank check company (i.e., a domestic company 1000) can be established for the purpose of acquiring foreign health care company. The underwriter or investment banker then solicits fund managers 1500, individual investors to invest in the company as shareholders 1400 in step 2010. The domestic company 1000 (i.e., a bank check company) and/or its agents (e.g., company's investment bankers) then searches for one or more suitable foreign health care companies 1200 to acquire or control in step 2020.

The investing entity 1300 invests in the domestic company 1000 in step 2030 and receives a right or warrant to invest, acquire, control or manage one or more foreign companies 1200 owned or controlled by the domestic company 1000. The investing entity 1300 then selects at least one foreign company 1200 from the plurality of foreign companies 1200 owned or controlled by the domestic company 1000 in step 2040. The domestic company 1000 arranges for financing directly or indirectly in a jurisdiction of the selected foreign company in step 2050, thereby enabling the investing entity 1300 to invest in the selected foreign company. Preferably, the financing amount is equal to or less than the investing entity's investment in the domestic company. In accordance with an aspect of the claimed invention, the financing amount is in currency of the foreign company 1200.

In accordance with an embodiment of the claimed invention, the domestic company 1000 selects the foreign companies 1200 based one or more financial/business criteria, such as EBITDA (earnings before interest, taxes, depreciation and amortization), annual revenue, net asset value, market share, annual sales, market capitalization for a public company and the like. In accordance with an exemplary embodiment of the claimed invention, the domestic company 1000 selects only foreign companies 1200 with net asset value greater than US $5 million.

Similarly, in accordance with an embodiment of the claimed invention, the domestic company 1000 accepts investment from an investing entity 1300 satisfying one or more financial/business criteria, e.g., investment amount, EBITDA, annual revenue, net asset value, market share, annual sales, market capitalization for a public company and the like. In accordance with an exemplary embodiment of the claimed invention, the domestic company selects only investing entities that can provide investment in excess of US $3 million.

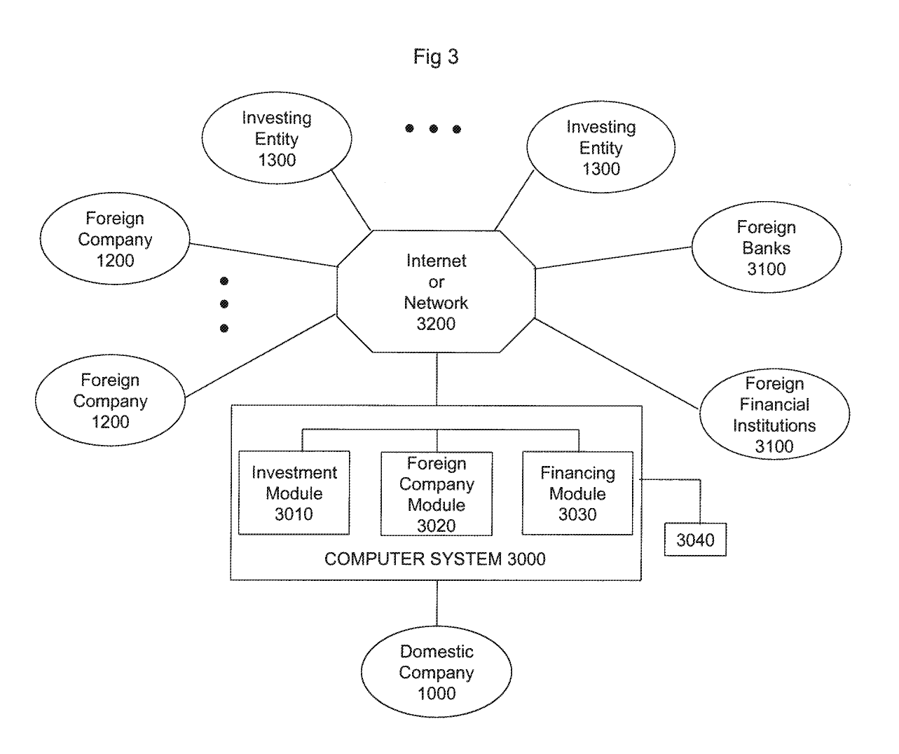

Turning now to FIG. 3, in accordance with an embodiment of the claimed invention, there is illustrated a processor based server or a computer based system 3000 for managing an investment in a foreign company, which is connected to computers of the domestic company 1000, the foreign companies 1200, investing entities 1200 and foreign banks and financial institutions 3100 via a communications network 3200, e.g., Internet. It is appreciated that each label, except Internet or Network 32000, in FIG. 3 represents a computer, a server, a computer system or the like that is under the control or located in the premises of the labeled party, e.g., the label “Investing Entity 1300” in FIG. 3 represents the computer of the Investing Entity 1300. Although, the computer of the domestic company 1000 is shown to be connected to the computer system 3000 in FIG. 3, the domestic company's computer can be connected to the computer system 3000 via the network 3200.

The processor based server 3000 comprises an investment module 3010, a foreign company module 3020, a financing module 3030 and a database 3040. The investment module 3010 processes investment by an investing entity 1300 in a domestic company 1000 holding interests in a plurality of foreign companies 1200 and stores the investment information of the investing entity 1300 in the database 3040. The foreign company module 3020 enables the investing entity 1300 to select at least one foreign company 1200 from a plurality of foreign companies 1200 stored in the database 3040. Preferably, the foreign company module 3020 provides stored description, including financial information, of each foreign company 1200 from the database 3040. The financing module 3030 arranges financing for the investing entity 1300 in a jurisdiction of the selected foreign company 1200 through a local foreign bank or financial institution 3100, thereby enabling the investing entity 1300 to invest in the selected foreign company 1200. The financing module 3030 stores the financing information for the investing entity 1300 in the database 3040. Preferably, the financing amount (i.e., in the currency of the selected foreign company) is less than or equal to the amount of the investing entity's investment in the domestic company 1000.

In accordance with an exemplary embodiment of the claimed invention, the computer of the investing entity 1300 communicates with the processor based server 3000 in a client/server relationship on a communications network 3290, such as the Internet. In a client/server environment, the processor based server 3000 communicates with various network enabled client devices or computers of the investing entities 1300, the foreign companies 1200, the foreign banks or financial institutions 3100, and the domestic companies 1000. The network enabled devices or computers can be a workstation, a computer system, a personal computer (PC), a hand-held electronic device (such as a PDA), a mobile or cellular wireless phone, a TV set, or any other web-enabled electronic device as would be understood by those of skill in the art.

The inventive system can utilize any type of electronic transmission medium 3200, for example, including but not limited to the following networks: a virtual private network, a public Internet, a private Internet, a secure Internet, a private network, a public network, a value-added network, an intranet, a wireless gateway or the like. The term “virtual private network” refers to a secure and encrypted communications link between nodes on the system, a Wide Area Network (WAN), Intranet, the Internet or any other network transmission means. In addition, the connectivity to the Internet can be via, for example, Ethernet, Token Ring, Fiber Distributed Datalink Interface, Asynchronous Transfer Mode, Wireless Application Protocol, or any other form of network connectivity.

The claimed invention can be implemented using hardware, software or a combination of hardware and software. Particularly, the inventive system and method can be implemented using a computer system with a single personal computer or a network of multiple computers in local area networks, wide area networks, intranets or the Internet. The inventive application can be implemented using either object-oriented programming languages, like the JAVA™ and C++ programming languages including in particular AJAX which allows portions of a webpage to be updated without reloading a page, or procedural programming languages such as the C programming language. JAVA is a registered trademark of Sun Microsystems, Inc. The inventive system and method can be implemented as a JAVA-based application accessible by multiple end user computers on a website available over the Internet. Preferably, the inventive system and method can be implemented as a Python-based application accessible by multiple end user computers on a website available over the Internet.

In accordance with an exemplary embodiment of the claimed invention, the inventive system can be provided as a software program that is part of a desktop or web-based application or framework such as a website that a user can access through the Internet by having an account with the website. The software program can be accessed from a website, downloaded from a website, stored on a tangible recordable medium, such as a disk, CD, DVD, flash memory or portable storage device and the like. For example, once an account is opened, the website can provide the user with the inventive software modules that allow the user to manage cross-border financing and an investment.

Although the claimed invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described herein. As one of ordinary skill in the art will readily appreciate from the disclosure of the claimed invention, processes, machines, manufacture, compositions of matter, means, methods, or steps, presently existing or later to be developed that perform substantially the same function or achieve substantially the same result as the corresponding embodiments described herein may be utilized according to the claimed invention. Accordingly, the appended claims are intended to include within their scope such processes, machines, manufacture, compositions of matter, means, methods, or steps.

We claim:

1. A system for managing cross-border financing and an investment over a communications network, comprising:
a database connected to said communications network; and
a processor based server connected to said communications network manages investment in a plurality of domestic and foreign companies, each domestic company operating in one jurisdiction and holding interests in a plurality of foreign companies operating in another jurisdiction and meeting one or more predetermined financial criteria established by said each domestic company; and
wherein said processor based server comprises an investment module, a foreign company module and a financing module to communicate with a plurality of computers over said communications network, each computer being associated an investing entity, a domestic company, a foreign company, a foreign bank or a foreign financial institution;
wherein said investment module of said processor based server provides a computer associated with an investing entity a list of said plurality of domestic companies from said database over said communications network, receives a selection of a domestic company, an investment amount and investment information from said computer associated with said investing entity over said communications network, stores said selected domestic company, said investment amount and investment information of said investing entity in said database, and processes the investment amount and said investment information in said selected domestic company by said investing entity;
wherein said foreign company module of said processor based server provides from said database to said computer associated with said investing entity a list of foreign companies that said selected domestic company holds interest in over said communications network, receives a foreign company selected by said investing entity from said computer associated with said investing entity over said communications network, stores said selected foreign company of said investing entity in said database, and provides said investing entity financial information of said selected foreign company over said communications network; and
wherein said financing module transmits cross-border financing information to said computer associated with said investing entity over said communications network to directly invest in said selected foreign company in said other jurisdiction by investing in said selected domestic company in said one jurisdiction by said investing entity.

2. The system of claim 1, wherein said financing module of said processor based server transmits said cross-border financing information for an amount equal to or less than the amount of investment in said domestic company by said investing entity.

3. The system of claim 1, wherein said financing module of said processor based server transmits said cross-border financing information for an amount available in a local currency of said selected foreign company in said other jurisdiction.

4. The system of claim 1, wherein said list of said plurality of foreign companies stored in said database comprises companies in one industry in one country.

5. The system of claim 1, wherein said list of said plurality of foreign companies stored in said database comprises companies in multiple industries in one country.

6. The system of claim 1, wherein said list of said plurality of foreign companies stored in said database comprises companies in one industry in multiple countries.

7. The system of claim 1, wherein said list of said plurality of foreign companies stored in said database comprises companies in multiple industries in multiple countries.

8. The system of claim 1, wherein said list of said domestic companies stored in said database comprises at least one private company.

9. The system of claim 1, wherein said list of said domestic companies stored in said database companies at least one public company.

10. The system of claim 9, wherein said list of said domestic companies stored in said database comprises said at least one public company formed via one of the following: reverse-merger or special purpose acquisition company (SPAC).

11. The system of claim 1, wherein said list of said foreign companies stored in said database comprises private and public companies.

12. The system of claim 1, wherein said foreign company module of said processor based server transmits information about each of said plurality of foreign companies to said associated computer of said investing entity over said communications network.

13. A computer based method for managing cross-border financing and an investment over a communications network, comprising the steps of:
accessing a processor based server over said communications network by an investing entity using an associated computer to obtain cross-border financing to directly invest in a foreign company, said processor based server manages investment in a plurality of domestic and foreign companies, each domestic company operating in one jurisdiction and holding interests in a plurality of foreign companies operating in another jurisdiction and meeting one or more predetermined financial criteria established by said each domestic company;
receiving a list of said plurality of domestic companies stored in a database from said processor based server by said associated computer of said investing entity over said communications network;
transmitting a selection of a domestic company from said list of said plurality of domestic companies, an investment amount and investment information to said processor based server by said associated computer of said investing entity over said communications network;
receiving a list of foreign companies stored in said database from said processor based server by said associated computer of said investing entity over said communications network after said processor based server processes and validates the investment amount and said investment information received from said investing entity, wherein said selected domestic company holds an interest in each foreign company on said list of foreign companies;
transmitting a selection of a foreign company from said list of foreign companies to said processor based server by said associated computer of said investing entity over said communications network;
receiving financial information of said selected foreign company stored in said database by said associated computer of said investing entity; and
receiving cross-border financing information from said processor based server by said associated computer of said investing entity over said communications network to directly invest in said selected foreign company in said other jurisdiction by investing in said selected domestic company in said one jurisdiction by said investing entity.

14. The computer based method of claim 12, further comprising the step of receiving said cross-border financing information for an amount equal to or less than the amount of investment in said domestic company by said investing entity.

15. The computer based method of claim 13, further comprising the step of receiving said cross-border financing information for an amount available in a local currency of said jurisdiction of said selected foreign company.

16. The computer based method of claim 13, further comprising the step of determining if the investment amount and said investment information satisfies a predetermined criteria established by said selected domestic company.

17. The computer based method of claim 13, further comprising the step of receiving information about each of said plurality of foreign companies from said processor based server by said associated computer of said investing entity over said communications network.

18. A computer readable medium comprising computer executable code for managing cross-border financing and an investment over a communications network, said computer executable code comprising instructions for:
accessing a processor based server over said communications network by an investing entity using an associated computer to obtain cross-border financing to directly invest in a foreign company, said processor based server manages investment in a plurality of domestic and foreign companies, each domestic company operating in one jurisdiction and holding interests in a plurality of foreign companies operating in another jurisdiction and meeting one or more predetermined financial criteria established by said each domestic company;
receiving a list of said plurality of domestic companies stored in a database from said processor based server by said associated computer of said investing entity over said communications network;
transmitting a selection of a domestic company from said list of said plurality of domestic companies, an investment amount and investment information to said processor based server by said associated computer of said investing entity over said communications network;
receiving a list of foreign companies stored in said database from said processor based server by said associated computer of said investing entity over said communications network after said processor based server processes and validates the investment amount and said investment information received from said investing entity, wherein said selected domestic company holds an interest in each foreign company on said list of foreign companies;
transmitting a selection of a foreign company from said list of foreign companies to said processor based server by said associated computer of said investing entity over said communications network;
receiving financial information of said selected foreign company stored in said database by said associated computer of said investing entity; and
receiving cross-border financing information from said processor based server by said associated computer of said investing entity over said communications network to directly invest in said selected foreign company in said other jurisdiction by investing in said selected domestic company in said one jurisdiction by said investing entity.

19. The computer readable medium of claim 18, further comprising instructions for receiving confirmation from said processor based server by said associated computer of said investing entity that the investment amount and said investment information provided by said investing entity satisfies a predetermined criteria established by said selected domestic company.

20. The computer readable medium of claim 18, further comprising instructions for receiving information about each of said plurality of foreign companies from said processor based server by said associated computer of said investing entity over said communications network.
